(19) United States
(12) Patent Application Publication
(10) Pub. No.: US 2005/0192771 A1
(43) Pub. Date: Sep. 1, 2005

(54) System and method for dynamically integrating remote portal fragments into a local portal

(75) Inventors: Peter Fischer, Kronach (DE); Stephan Hesmer, Holzgerlingen (DE); Thomas Schaeck, Achern (DE)

Correspondence Address: Intellectual Property Law Dept.;IBM Corporation, 11400 Burnet Road 4054, Austin, TX, 75758, US

(73) Assignee: INTERNATIONAL BUSINESS MACHINES CORPORATION, ARMONK, NY (US)

(21) Appl. No.: 10/675,743

(22) Filed: Sep. 30, 2003

(30) Foreign Application Priority Data
Dec. 20, 2002 (DE) 02102869.1

(51) Int. Cl. G01M 19/00

(52) U.S. Cl. 702/122; 707/100

(57) ABSTRACT

The present invention provides a system and method for dynamically integrating remote Portal fragments into a local Portal while maintaining the look and feel of the local Portal by receiving Meta-information of the remote Portal fragment, integrating said Meta-information into the existing navigation tree of the local Portal resulting in an new navigation tree, traversing the new navigation tree for rendering the integrated Portal page, identifying references in the new navigation tree for remote Portal fragments, establishing Communication with the remote Portal, and receiving and including remote Portal fragments into the local Portal page. The present invention secures a seamless integration of Portal fragments into the local Portal while maintaining the local Portal's look and feel.

The present invention relates to a system and method to dynamically integrate content from remote systems into the Portal, and more particularly to dynamically integrate remote Portal fragments into a local Portal while maintaining the look and feel of the local Portal.

### BACKGROUND OF THE INVENTION

The Portal market is one of the fastest growing markets of computer software. A Portal in the present invention may be defined as an application which provides a secure, single point of interaction with diverse information, business processes, and people, personalized to a user's needs and responsibility. The huge demand drives rapid development of new technologies by different Portal vendors in order to place their products in good market positions. Therefore, it is not surprising that Portals already ran through different evolutionary phases. In a first step, the Portals were mainly used as access points to different information sources and content was solely chosen by the Portal operator. Soon after that, the users got the possibility to influence the displayed contents and customization was born. This was a great step forward because the user was able to select information according to personal interests and to find relevant information faster. The potential of such user customized information delivery was also interesting in the field of intra business information distribution and the first business or corporate Portals were introduced.

The ongoing evolution also left its footprint in the architecture of Portal products. At first, Portal-like products were delivered as pre-packaged applications that could be installed out of the box and included standard applications, which provided all functionality of the Portal. Step by step, new applications were needed and the vendors extended their products in order to satisfy those requirements. Due to the usage of proprietary designs, the vendors were the only ones, who added new functionality to their Portals and therefore the success of a Portal was closely related to the applications it brought along. This led to the decomposition of the monolithic structures and to the creation of Portal frameworks.

The Portal products offered today employ Portal architectures where a Portal itself only implements standard functionality like security, authorization, authentication, aggregation, caching, user management, enrollment, rendering and so on and provides the infrastructure for application components. This architecture includes APIs for the integration of applications so that applications from different partners can be used as long as they match the Portal product's API. In the Portal environment, these applications are typically called Portlets.

Portlets are pluggable components that can be added to Portals and are designed to run inside a Portal's Portlet container. Portlets may provide different functions ranging from simple rendering of static or dynamic content to application functions such as e-mail, calendar, etc. Portlets are invoked indirectly via the Portal application and produce content that is suited for aggregation in larger pages, e.g. Portlets should produce mark-up fragments adhering guidelines that assure that the content generated by different Portlets can be aggregated into one page. Typically, Portlets run on the Portal-Server, processing input data and rendering content locally. Often, the content for Portlets which are displayed very often is cached locally to improve response times, performance and scalability of Portals. While local Portlets typically provide short response times, this approach is not well suited to enable dynamic integration of business applications and information sources into Portals.

More and more local Portlets running in a Portal environment using Web-Services provided by Web-Service-Provider. Web-Services may be defined as providing existing or software components into a service-oriented architecture (SOA).

In contrast to these major changes, the used customization concepts haven not changed significantly. The biggest difference is that users nowadays choose Portlets from a list provided by the Portal administrator. However, there is no way to dynamically integrate whole page structures or page groups of remote Portals into an origin Portal.

Presently there are two basic concepts for displaying remote whole pages structures or page groups of remote Portals into a Local Portal:

Portal pages or Web sides display a link to a certain remote Portal. The user has to click on this link and the remote Portal page is displayed in a new browser window by loading all information from the Portal server directly. This means that even the markup including the look and feel of the remote Portal page generated on the Portal server side remains unchanged.

New browsers support Portal pages or web sites which include frames enabling a Portal page or web site to display remote Portal page as a part of their own Portal page. The look and feel of the content provider's Portal page generated on the Portal server side remains unchanged too.

The disadvantages of these concepts may be summarized as follows:
the user has to accustom to the different look and feel of the remote Portal page,
the remote Portal page is not integrated into the requesting Portal page,
there is no integration of navigation between local and remote Portal page,
the rendering of the remote Portal page is exclusively performed at the remote Portal server side and can therefore not be influenced.

In summary, today's Portals are usually Portal pages hosted by a company that provide links to Portal of an other companies. In the future it will be necessary to not only to link to other Portal pages but also to includes parts or so called Portal fragments into the Local Portal, so that the user has the experience or look and feel of one Portal but still has access to functions and content of other Portals without permanently accustoming to the different Portal specific look and feel.

U.S. Pat. No. 6,128,655 discloses an automated system for replicating published web content and associated advertisements in the context of a hosting web site. At the hosting web site, the invention includes the process of brokering a client's browser request for a web page, analyzing the returned content and splitting it into components elements, extracting the desired component elements, recasting the desired elements in the look and feel of the hosting side and sending the recast content to the requesting client web page. Once the reformatted file is received at the client, the client browser interprets the HTML in the web page, presenting the content in the context of the hosting web site. On the content provider's web site, the details of the transaction in the web server logs are preserved, proxying a direct page view and ad impression.

That patent is only working with static web content. It processes the web content and generates new pages. The processing of a page is defined that either the web content contains control-tags, so that the processing is able to parse and recognize the content of the page or a defined filter is used to parse and recognizes the format of the page. This approach is unflexible as one filter represents a specific format of the web content, so that only web content of the same kind/format can be processed with the same filter.

The patent is not dealing with the structure/navigation of a web site and dependencies of a web site's pages. It is also not dealing with the integration of a navigation and the referenced content from a remote portal into a local portal.

It is therefore object of the present invention to provide a system and method for dynamically integrating of whole page structures or page groups of remote Portals into a local Portal while maintaining the look and feel of the local Portal.

This object is solved by the independent claims.

Further advantageous embodiments of the present invention are laid down in the dependent claims.

### SUMMARY OF THE INVENTION

The present invention provides a system and method for dynamically integrating remote Portal fragments into a local Portal while maintaining the look and feel of the local Portal by receiving Meta-information of the remote Portal fragment, integrating said Meta-information into the existing navigation tree of the local Portal resulting in an new navigation tree, traversing the new navigation tree for rendering the integrated Portal page, identifying references in the new navigation tree to remote Portal fragments, establishing communication with the remote Portal, and receiving and including Portal fragment into the local Portal page.

The present invention secures a seamless integration of the Portal fragments into the local Portal while maintaining the local Portal's look and feel.

Both the foregoing general description and the following detailed description are exemplary and explanatory only and are not intended to restrict the claimed invention. The accompanying drawings, which are incorporated in and constitute a part of this specification, illustrate embodiments of the invention, together with the description, explain the principles of the invention.

### BRIEF DESCRIPTION OF THE DRAWINGS

FIG. 1 shows an example of Portal page,

FIG. 2 shows a prior art Portal server architecture on which the present invention may be based preferably,

FIG. 3A/B show the process of generation a Portal page as used by the prior art Portal server architecture FIG. 2,

FIG. 4 shows the prior art Portal server architecture as shown in FIG. 1 extended by the present invention,

FIG. 5A-C show a preferred embodiment of the integration of Portal fragments into the local Portal,

FIG. 6 shows the Dynamic Portal Assembly as preferably used by the embodiment of FIG. 5A-C, and

FIG. 7A-B show a floating diagram with a preferred embodiment of the complete inventive process.

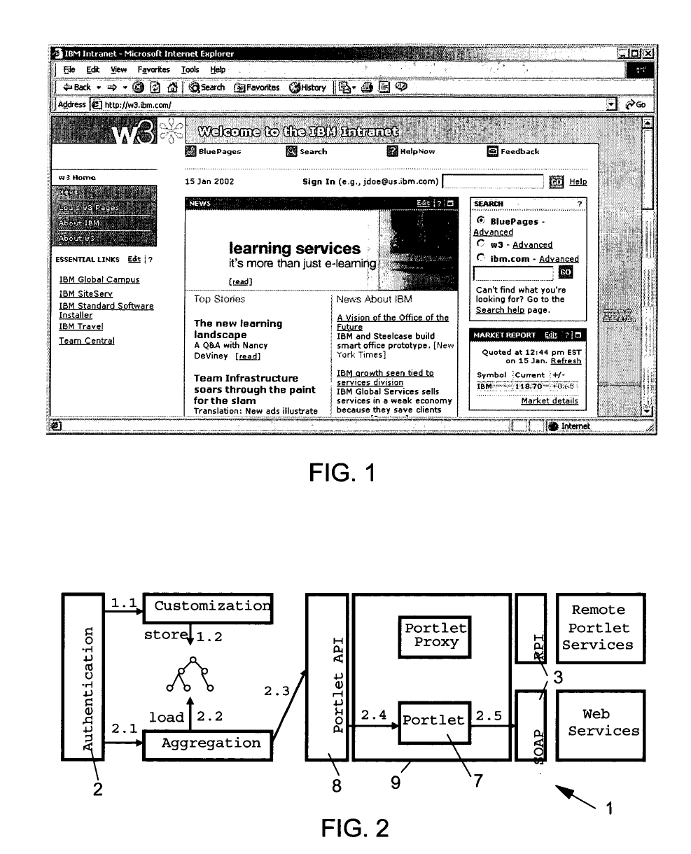

FIG. 1 shows as an example an IBM Intranet Portal page. All IBM Portal pages have a standardized layout. Integrating of foreign or remote Portal fragments into IBM's Intranet Portal page would require to maintain the look and feel of IBM's Portal layout. IBM's Portal Page is divided into the areas W3 Home, News, Top Stories, Search, News About IBM, and Market Report. All information which is displayable via IBM's Portal page does not need to be available locally but can be distributed all over the world and can be collected and displayed for a single user.

FIG. 2 shows the architecture of the abstract Portal model 1 which serves as the basis for the present invention. As this model uses a local Portlet API 8 and a protocol for invocation of Remote Portlet Web Services 3 (RPI). Each incoming request passes through authentication component 2 in order to determine and to prove the user's identity (2.1). The Portal 1 uses this identity to obtain the data needed for aggregation 2 (2.2). During aggregation, the Portal calls Portlets 7 (2.3) and assembles the returned markup into pages that it returns to the client device. Portlets 7 are executed within a Portlet container 9 and accessed via the Portlet API 8. The Portlets can access additional services using RPI or SOAP 3 (2.5).

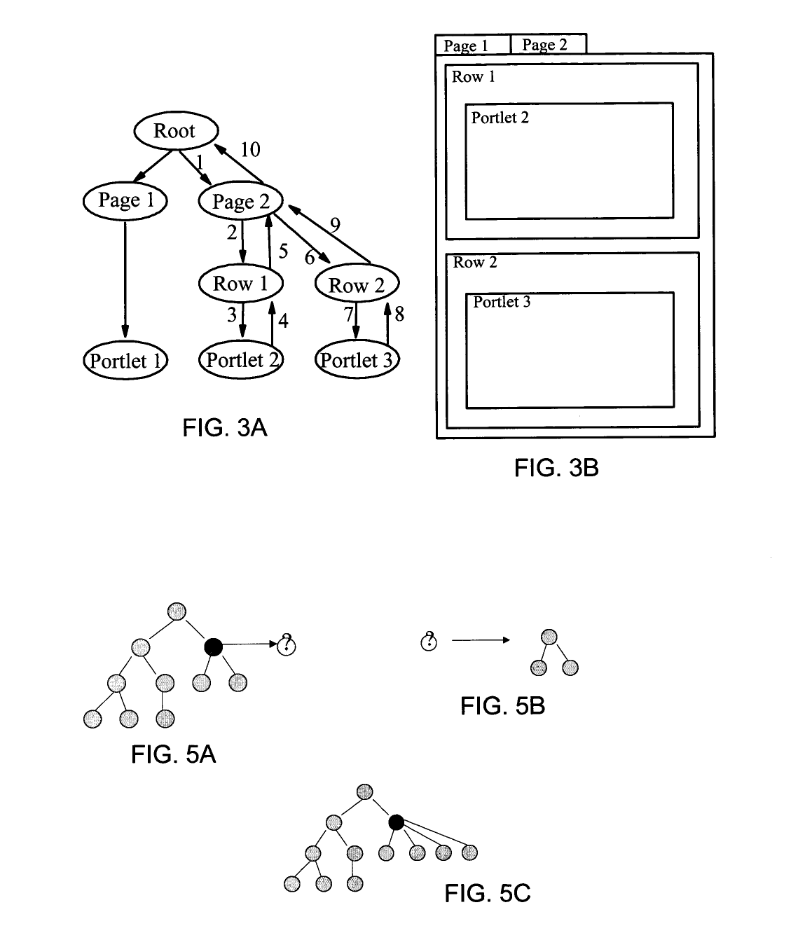

FIG. 3A/B shows the process of generation a Portal page as used by the prior art Portal server architecture FIG. 2. The relevant part of the Portal for the present invention is the aggregation component. The aggregation component performs all steps that are required to assemble a page that is sent back to the client. Typically, these steps are to load a navigation tree from storage, to traverse it (see steps 1 to 10 in FIG. 3A) and to call the instances referenced in the tree in order to obtain their output, which is assembled to a single page.

The navigation tree may be defined as the relationship as well as the arrangement of the components that are used to create the visual representation of the Portal page. The navigation tree will be defined through customisation by the administrators or users and saved in the database.

The abstract Portal model defines components that are used as node types in the navigation tree. These components are Page Group, Pages, Container, and Portlet instances. A Page Group is used in order to create a hierarchical navigation structure. Page Groups can themselves contain page groups or pages, but not both types at one time. Pages are the lowest elements in the navigation hierarchy. Pages have containers as children. Containers are used to structure the content of a page (see FIG. 3B, Row 1, Row 2).

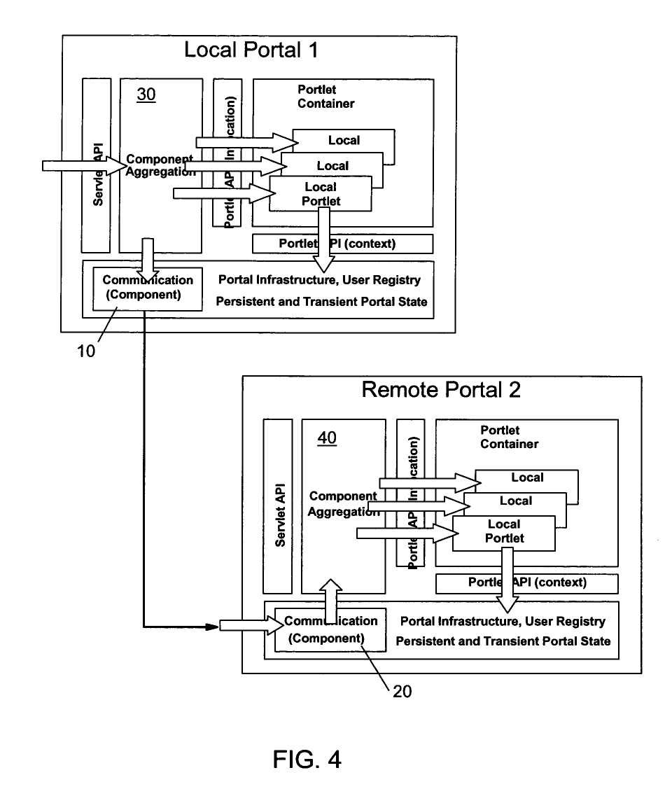

FIG. 4 shows the prior art Portal server architecture extended by the present invention. To realize the present invention the new Portal server needs at least two components that either need to be modified or created. These components are the aggregation 30, 40 and the Communication component 10, 20. In a preferred embodiment a Transformation component may be additionally used. The Aggregation component 30, 40 needs to be able to insert references into its internal tree representation which represent remote Portal fragments. The reference may be created for example by the Customization component which enables an administrator to type in the required information to connect to the remote Portal. While traversing the tree the Aggregation component 30, 40 needs to be able to contact the remote Portal 2 and receive Meta-information from the remote Portal. The Meta-Information completely describes the navigation tree of the Portal fragment. The Meta-information which will be provided to the local Portal 1 is part of the already existing Meta-information of the remote Portal page and does not need to be generated additionally. It is used to transfer all needed information in a unified way between the portals 1, 2. For example the Meta-information may contain following navigation information of the portal fragment to be included into the local Portal:
Root-Node+Node-Properties+Display-Information
   Child-Node+Node-Properties+Display-Information
      . . .
      . . .
   . . .
   . . . Node-Properties
   Kind of Node like (Page, Portlet, Column, Row, . . . )
   Remote reference
   Display-Information
   Title for each supported language
   Description for each supported language
   Keywords for each supported language,

In summary the Meta-information describes a portal fragment with its navigation tree information.

The navigation information contained in the Meta-information is used to create a new navigation tree containing the existing local navigation tree and the navigation tree of the remote Portal fragment. Then, the local Portal 1 renders a specific side displaying also a part of the remote Portal fragment.

The Communication component 10, 20 allows the communication between the local Portal 1 and remote Portal 2. When the Aggregation component 30, 40 has identified a reference in its navigation tree to a remote Portal 2, it establishes a communication to the remote Portal 2 by using the Communication component 10, 20. During the first request for Meta-information the local Portal's aggregation component 30 must send information about the Portal fragment to be integrated, the Communication component of the remote Portal 20 receives that requests, analyses it, extracts the portal fragment to be integrated, and gives that information to Aggregation component 40 of the remote Portal 2. The Aggregation component 40 creates the whole internal tree by loading the navigation data from storage, extracts the requested portal fragment, and gives it to the transformation component (not shown). The transformation component generates the Portal fragment in a standardized XML document format. The standardized XML document is provided to the Communication component 20 of the remote Portal 2 which transfers it to the Communication component 10 of the local Portal 1. The Communication component 10 of the local Portal 1 provides the standardized XML document to the transformation component of the local Portal 1. The transformation component of the local Portal transforms the standardized XML document into the format of the existing navigation tree of the local Portal 1, and then the aggregation component 30 merges the portal fragment with the existing tree resulting in a new tree. While traversing this tree the local look and feel is being applied to all parts of the new tree independent of the look and feel of the remote Portal 2. The look and feel is applied by the aggregation component 30 that means that the rendering of the different pages, container, portlets, is determined by the Aggregation component.

The Aggregation component 30 of the local Portal 1 must be modified to be able to request and receive Portal fragments from remote Portals via Communication component 10,20. The Aggregation component 40 of the remote Portal 2 must be modified to receive request for Portal fragments and to return Portal fragments via Communication component 20.

FIG. 5 shows a preferred embodiment of the dynamic integration of Portal fragments into the local Portal.

The dynamic integration of Portal fragments into the local Portal is preferably accomplished by using the Dynamic Portal Assembly concept. Using this concept, it is possible to generate the tree dynamically and nodes appear or disappear between two requests to the portal. The Dynamic Portal Assembly works as follows:

Nodes of the existing tree can be marked as Dynamic Nodes (see FIG. 5A). A Dynamic Node is defined as a node of the existing navigation tree of the local Portal that references a Fragment placeholder (see question mark in FIG. 5A). A Fragment placeholder is defined as node that is resolved at runtime and replaced by a navigation tree of a Portal fragment (see FIG. 5 B). At runtime the Fragment placeholder is resolved and the appropriate Portal fragment is created (see FIG. 5B). Thereafter, the existing tree is merged with the sub tree (Portal fragment) of the Dynamic Node yielding the following in FIG. 5C.

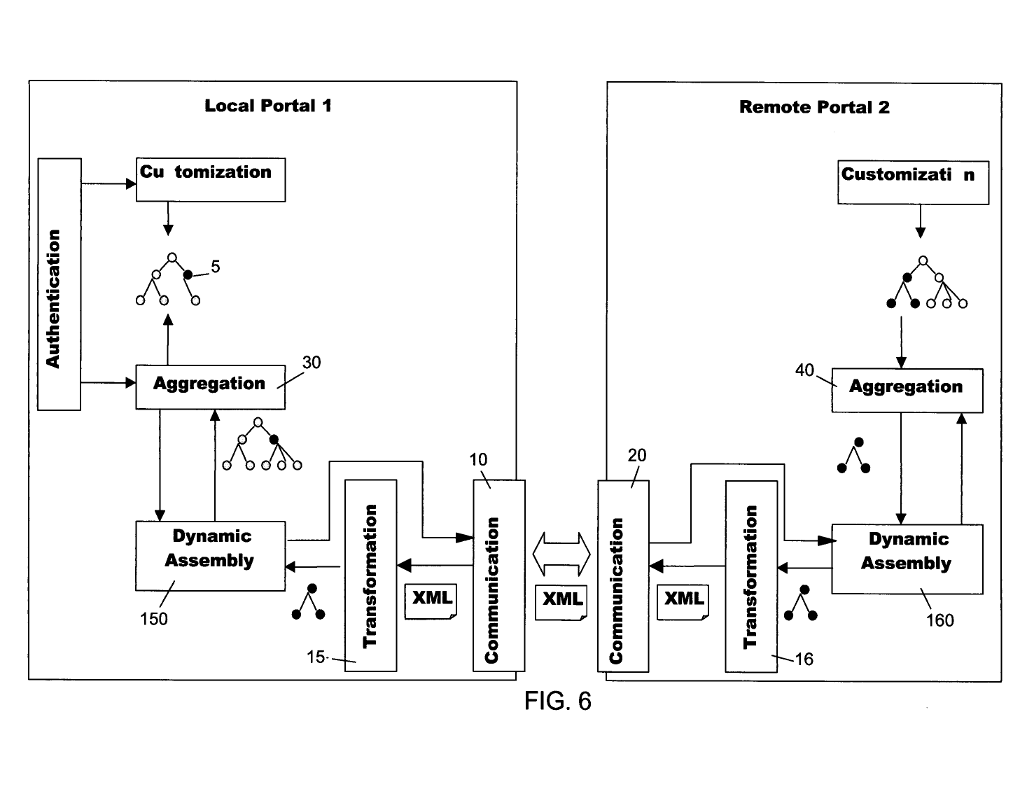

FIG. 6 shows the abstract prior art Portal Model extended by the inventive Dynamic Portal Assembly concept.

Dynamic Assembly works as follows: Nodes of a navigation tree can be marked as Dynamic Nodes. A Dynamic Node references a Fragment placeholder. At runtime, the Fragment placeholder is resolved and the appropriate Portal fragment is created. Thereafter, the Portal fragment is merged with the sub tree of the Dynamic Node.

In order to enable the Dynamic Assembly concept, the abstract Portal model needs several extensions including a Dynamic Assembly component that is responsible for resolving the Fragment placeholders.

For example the Fragment placeholder Info contains all fragment relevant data like IsRemote (determines whether the fragment is remote or not), URL (the URL under which the fragment can be resolved, in case that it is remote), ObjectID (the object id of the page group that a published fragment represents), Markups (the supported markups), Locales (the supported locales), Title (the title of the fragment placeholder), Desc (the description of the Fragment placeholder), Parameter (a set of name value pairs that can contain additional properties), and AdapterConfig (the configuration of the Adapter, e.g. properties contained in a deployment descriptor).

The two first steps of the processing of an incoming request are as before. However, the loaded existing navigation tree of the local portal page contains as a reference a Dynamic Node 5. Therefore, Dynamic Assembly 150 is invoked in order to resolve the Dynamic Node 5. Dynamic Assembly 150 in turn calls Communication component 10 which actually delivers the Meta-information via the Transformation component 15 to the Dynamic Assembly 150. In the latter case, the Communication component 10 accesses a remote Portal 2 via the Communication component 20 of the remote Portal 2. The Communication component 10 of the local Portal 1 may communicate with the Communication component 20 of the remote Portal 2 either using APIs or SOAP. The returned Meta—information which includes the navigation tree of the portal fragment is validated and merged with the existing navigation tree by the Dynamic Assembly 150. The Dynamic Assembly is preferably part of the aggregation component.

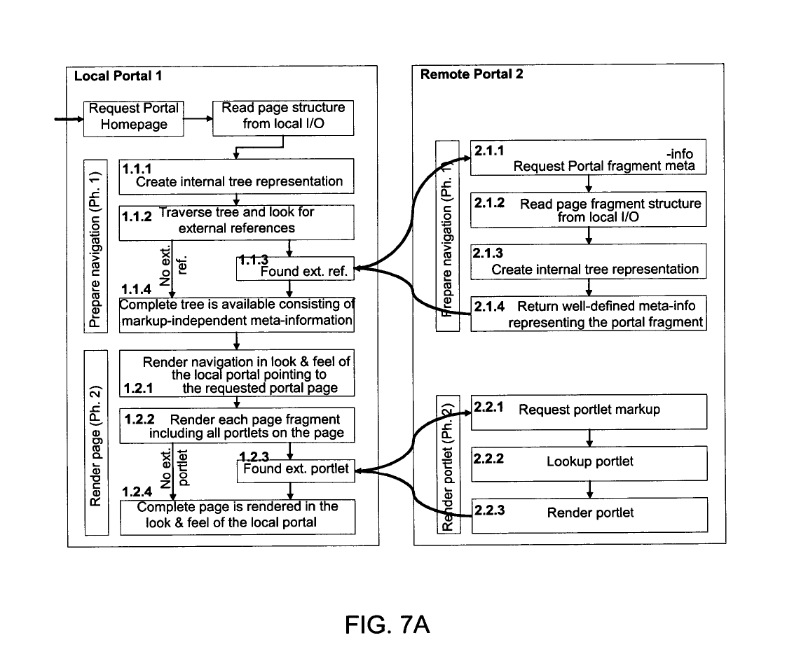

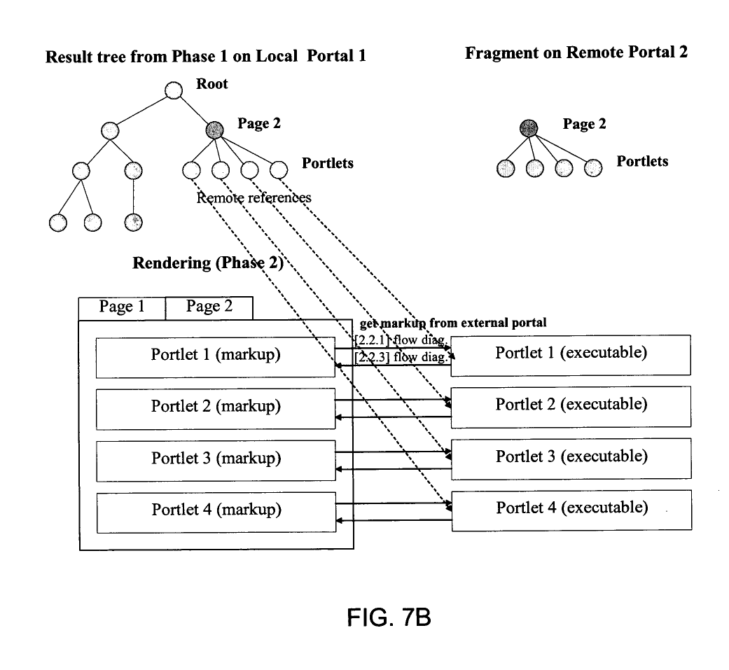

FIG. 7A-F show a floating diagram with a preferred embodiment of the complete inventive process. The complete inventive process may be divided into navigation phase on the local Portal, navigation phase on the remote Portal, and rendering of the portal page based on the new tree.

Prepare navigation (Phase 1) on the local Portal in detail.

This phase is preferably based on the Dynamic Portal Assembly concept. It works briefly as follows:

One node of a topology tree is marked as Dynamic Node, referencing to a remote Portal. A Dynamic Node references a Fragment placeholder (1.1.2).

At runtime, the Fragment placeholder is resolved and the appropriate Portal fragment is created (1.1.3). Therefore, the local Portal processes the received Meta-Information from the remote Portal, transforms it into its own internal representation and builds a tree that is ready-to-be integrated in the local Portal.

Thereafter, the existing tree is merged with the sub tree of the Dynamic Node (1.1.4).

Prepare navigation (Phase 1) on remote Portal in detail.

The local Portal requests a Portal fragment tree from the remote Portal (2.1.1).

The remote Portal processes the requested Portal fragment, transforms it into Meta-Information and builds a ready-to-be-send tree (2.1.2+2.1.3).

Thereafter, the Portal fragment (represented in Meta-Information) is returned to the local Portal (2.1.4).

Rendering page (Phase 2).

The rendering phase starts after the complete topology is available in the local Portal. The local Portal traverses through the complete tree to render the page. Therefore, the Portal renders node-specific markup at each node throughout the process. When the portal encounters a node with a remote reference (as shown in FIG. 7B), it resolves the link, connects to the remote Portal and includes the received markup into the page (2.2.1-2.2.3).

1. Portal-Server system comprising:
component to add references in an existing navigation tree of the local Portal (1) page representing a placeholder for a navigation tree of a Portal fragment of a remote Portal (2),
component (10) to establish communication with said remote Portal (2) and to receive Meta-information of said Portal fragment via a Communication component (20) of said remote Portal (2), wherein said Meta-information completely describes the navigation tree of said Portal fragment,
component (30) to merge said existing navigation tree of said local Portal (1) with said navigation tree of said Portal fragment resulting in a new navigation tree, and to traverse said new navigation tree by applying the look and feel of said local Portal (1).

2. Portal-Server system according to claim 1, further comprising a transformation component (15) at said local Portal (1) side which receives the Meta-information in a standardized XML-format and transforms it into the format of said existing navigation tree of said local Portal (1).

3. Method for dynamically integrating of remote Portal fragments into a local Portal while maintaining the look and feel of the local portal, characterized by the steps of:
identifying a reference in an existing navigation tree of local Portal page representing a placeholder for a navigation tree of a remote Portal fragment,
establishing communication with said remote Portal,
receiving Meta-information from said remote Portal describing the navigation tree of said Portal fragment to be integrated,
merging existing navigation tree with the navigation tree of the Portal fragment to be integrated resulting in a new navigation tree,
rendering an integrated Portal page by traversing said new navigation tree, identifying references to remote Portal fragments in said new navigation tree, establishing communication with said remote Portals, and receiving the markup of said portal Fragments for displaying said Portal fragment into said integrated page.

4. Method according to claim 3, wherein the Meta-information is generated by the following steps:
loading navigation tree of the remote Portal page if a Portal fragment request is received by the remote Portal,
extracting navigation tree of said Portal fragment to be integrated from said navigation tree of said remote Portal, putting said navigation tree of said remote Portal fragment into a XML document.

5. Method according to claim 4, wherein said Meta information is received by said local Portal in a standardized XML format.

6. Method according to claim 5, wherein said Meta-information is converted from said standardized XML format into the format of the existing navigation tree of the local Portal before merging.

7. Computer program product stored in the internal memory of a digital computer, containing parts of software code to execute the method in accordance with claim 4 if the product is run on the computer.
